(19) United States
(12) Patent Application Publication
(10) Pub. No.: US 2017/0281472 A1
(43) Pub. Date: Oct. 5, 2017

(54) BABY BOTTLE

(71) Applicant: Gregory D. Bender, Portmouth (OH)

(72) Inventor: Gregory D. Bender, Portmouth (OH)

(21) Appl. No.: 15/084,447

(22) Filed: Mar. 29, 2016

(51) Int. Cl. A61J 9/06; A61J 11/04; A61J 17/02; A61J 11/00

(52) U.S. Cl. CPC A61J 9/0684; A61J 11/008; A61J 11/04; A61J 9/0669; A61J 9/0623; A61J 17/02

(57) ABSTRACT

A baby bottle is equipped with a removable nipple, a removable teething ring interconnects the bottle with a suction cup base in a manner to permit controlling position of the nipple about a limited spherical range of movement.

### BACKGROUND

### 1. Field

This invention relates to baby bottles. More particularly, the invention relates to an ergonomically designed baby bottle to assist a baby in teething as well as use in drinking at a table.

### 2. General Background

There are various baby bottles on the market, some having unique functions and features. The prior art has many types of baby bottle constructions. However, none of the bottles appear to address needs that arise to collectively facilitate balance, handling, and ease of feeding infants and teething.

While some are adequate for the purpose and function for which they have been designed, they fail to provide a simple, efficient, and practical feeding bottle. None of the known bottles provide the features of the present invention. In particular, the prior art fails to disclose a bottle constructed to enhance an infant's grasp of the bottle, range of motion, and comfort while gripping the bottle while securing the same to a table top during the feeding process. The invention provides limited yet friendly use when secured in a holder and also provides a teething ring attached to the bottle. There is a need for an improved ergonomically designed baby bottle construction that simplifies feeding and teething, and the support functions associated with this, and permits easy and convenient bottle support when not in use.

### SUMMARY OF THE INVENTION

It is an object to provide a baby bottle to facilitate drinking at a table making feeding an easier function for the feeding person.

It is another object to provide a baby bottle with a limited yet friendly range of motion during feeding of a baby at a table.

Another object is to provide a removable teething rod from a bottle.

Still another feature is to provide a removable handle for carrying a baby bottle.

Accordingly, the invention is directed to a baby bottle having a container with a bottom, an open neck and a removable top equipped with a removable nipple. A removable teething ring is connected, e.g., pivotally, to the bottom. A base is provided having an upper portion with a recess surface for receiving a part of the teething ring in a supporting retaining manner. The upper portion has a lower side with a bearing surface. A suction cup is provided having a concave under surface and a convex outer surface to which a bearing connector is connected, wherein the bearing connector is operably received within the bearing surface of the upper portion in a manner to permit the upper portion limited rotational movement with respect to the suction cup. A handle is connected to the bottle permitting a baby to grasp the same for controlling position of the bottle, in both lateral and vertical position of the nipple, i.e., position of the nipple is permitted about a limited spherical range of movement.

### BRIEF DESCRIPTION OF THE DRAWINGS

FIG. 1 is a front perspective view of a baby bottle with the base showing my new design.

FIG. 2 is a top view thereof.

FIG. 3 is a bottom view thereof.

FIG. 4 is a side view thereof, of which the opposite side view is substantially identical.

FIG. 5 is a back view thereof of which the opposite side view is substantially identical and which shows a hidden bearing surface.

FIG. 6 is an exploded view of some of the parts of the invention.

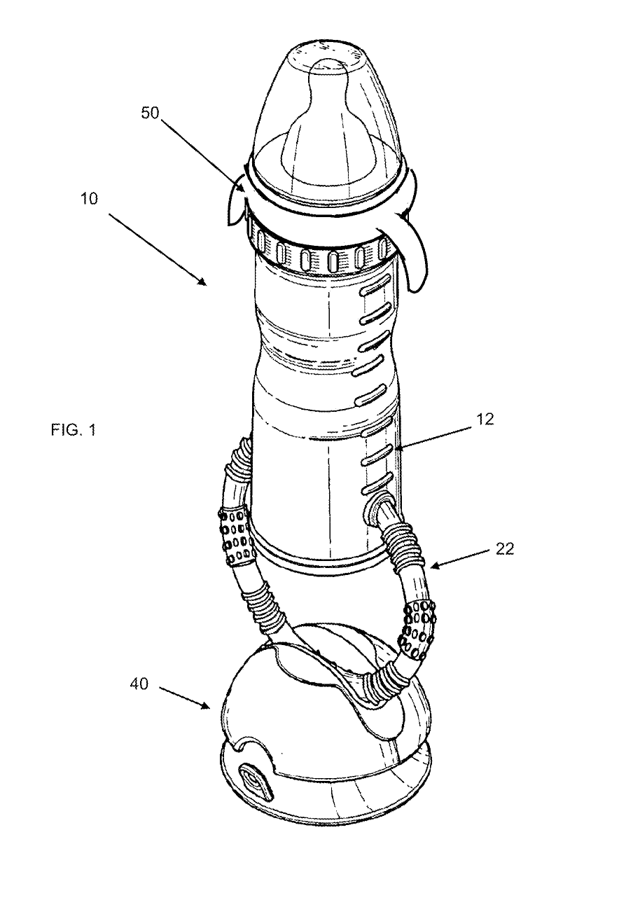

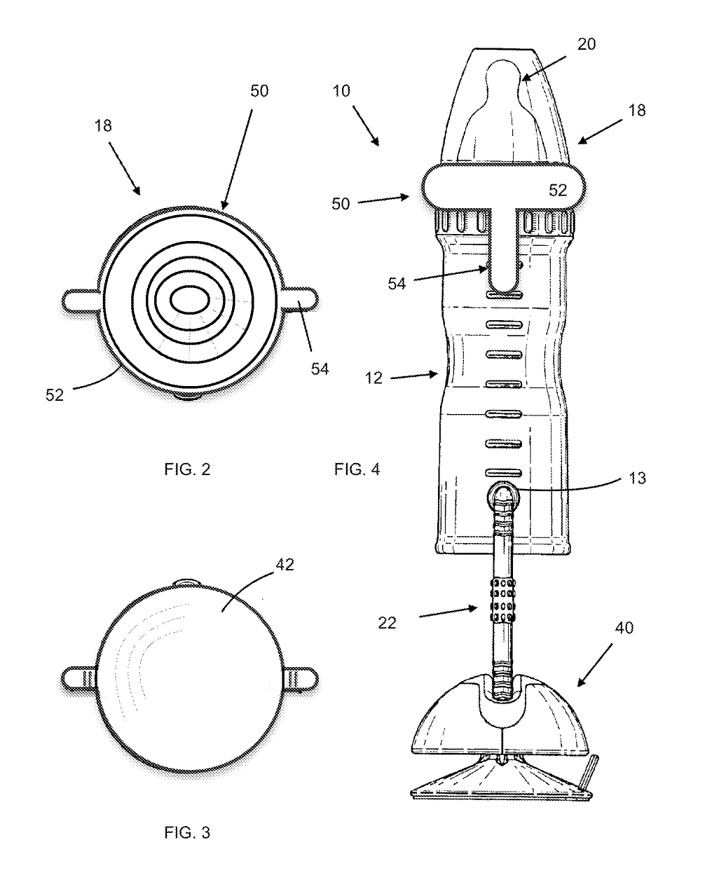

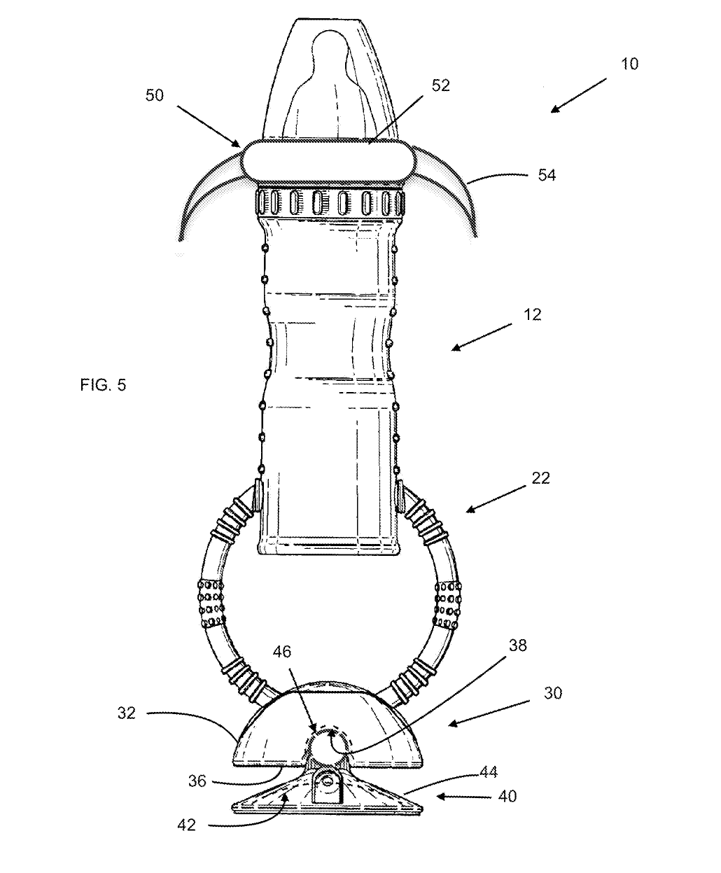

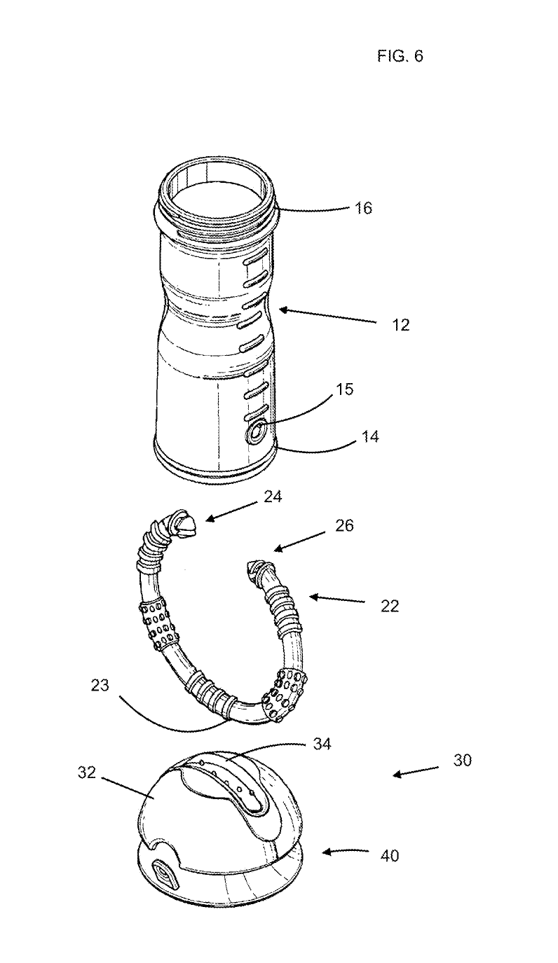

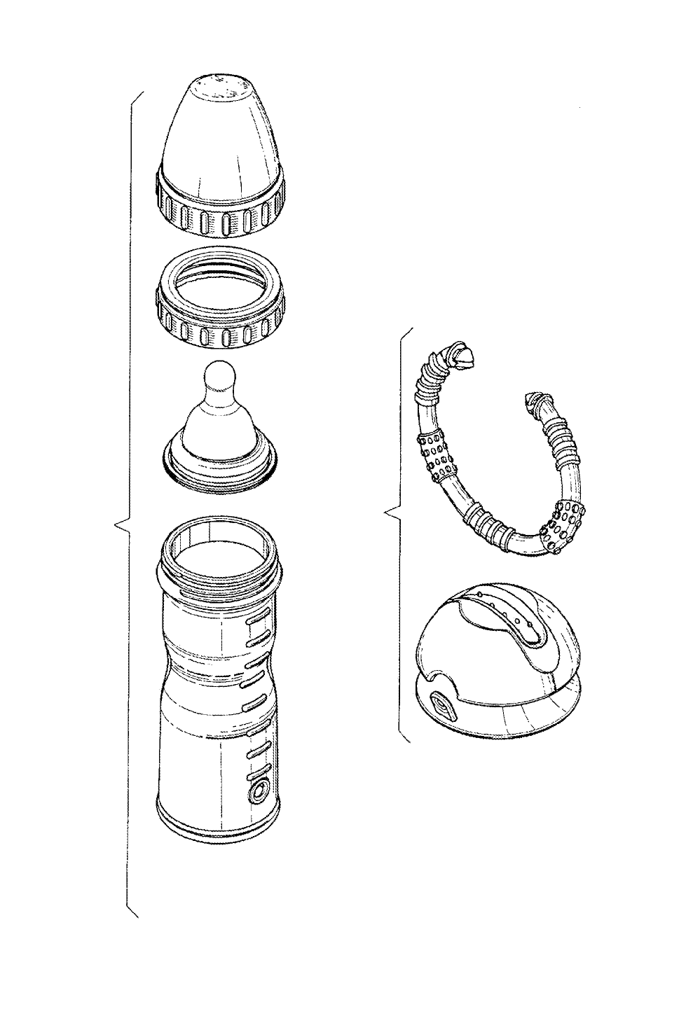

### DETAILED DESCRIPTION OF THE PREFERRED EMBODIMENT

Referring now specifically to the drawings, the baby bottle of the present invention which is generally designated by the numeral 10. The baby bottle 10 has a container 12 with a bottom 14, a neck 16 and a removable top 18 which equipped with a removable nipple 20.

A removable teething ring 22 is connected, e.g., pivotally, to the bottom 14. The teething ring 22 is generally ring shaped with gap to provide two ends 24 and 26. By virtue of the ring 22 being made of a flexible plastic material, for example, permitting the ends 24 and 26 to be displaced so that they can be removably received within the side receiving surfaces 13 and 15 of bottom 14. In this way, the teething ring 22 can be used as a handle as part of the bottle 10 or can be entirely removed as a separate teething tool.

A base 30 is provided having an upper side 32 with a recess surface 34 for receiving a part 23 of the teething ring 22 in a supporting retaining manner. The upper portion 32 has a lower side 36 formed with a receiving bearing surface 38 depicted in dotted line. A suction cup 40 is provided having a concave under surface 42 depicted in dotted line and a convex outer surface 44 to which a bearing connector 46 is connected. The bearing connector 46 is operably received within the bearing surface 38 of the upper portion 32 in a manner to permit the upper portion 32 limited rotational movement with respect to the suction cup 40.

A handle 50 has a ring 52 with laterally extending arms 54, wherein the ring 52 is connected about the bottle 19. When assembled, the suction cup 20 can be pressed to a smooth top such as a baby table top in a manner to cause the same to be held thereto by way of suction as in commonly known. This permits a baby to grasp the handle 50 for controlling position of the bottle 10 in both lateral and vertical position of the nipple 20, i.e., position of the nipple 20 is permitted about a limited spherical range of movement. In use, the bottle 10 provides multi-positions with the suction cup 40 fixed to a predetermined position providing a versatile baby bottle 10 adaptable for use in various orientations.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention as claimed.

What is claimed is:

1. A baby bottle, which includes:
a container with a bottom, an open neck and a removable top equipped with a nipple;
a teething ring connected to said container;
a base having an upper portion with a recess surface for removably receiving a part of said teething ring in a supporting retaining manner, wherein said upper portion has a lower side with a receiving bearing surface;
a suction cup is provided having a concave under surface and a convex outer surface to which a bearing connector is connected, wherein said bearing connector is operably received within said receiving bearing surface of said upper portion in a manner to permit said upper portion limited rotational movement with respect to said suction cup; and
a handle connected to said bottle permitting a baby to grasp the same, such that when said suction cup is secured to a surface, and said teething ring interconnects said base and said container, and said top and nipple connect to said container, said nipple is permitted a limited spherical range of movement.

2. The baby bottle of claim 1, wherein said teething ring is pivotally connected to said bottom.

3. The baby bottle of claim 2, wherein said teething ring is removably connected to said bottom.

4. The baby bottle of claim 1, wherein said teething ring is removable connected to said base.

5. The baby bottle of claim 1, wherein said teething ring is removably connected to said container.
